(19) United States
(12) Patent Application Publication
(10) Pub. No.: US 2015/0089635 A1
(43) Pub. Date: Mar. 26, 2015

(54) SYSTEM FOR CORRELATION OF INDEPENDENT AUTHENTICATION MECHANISMS

(71) Applicant: LaserLock Technologies Inc., Washington, DC (US)

(72) Inventors: Neil ALPERT, Washington, DC (US); Paul DONFRIED, Richmond, MA (US); Norman A. GARDNER, Bala Cynwyd, PA (US)

(21) Appl. No.: 14/490,052

(22) Filed: Sep. 18, 2014

Related U.S. Application Data
(60) Provisional application No. 61/880,517, filed on Sep. 20, 2013.

(51) Int. Cl. G06F 21/31; G06F 21/36

(52) U.S. Cl. CPC G06F 21/31; G06F 21/36; G06F 21/316
USPC 726/19

(57) ABSTRACT

Described are devices, methods and non-transitory computer readable media for implementing an enhanced multi-factor authentication system. The system uses three user identifiers, and after a first user identifier is verified, the system receives a second user identifier from the user. As the second user identifier is being received, the system automatically detects a third user identifier and verifies simultaneously the second and third user identifiers. The second and third user identifiers are correlated with each other, and the correlation of these two identifiers (e.g., in addition to the identifiers themselves) is also verified.

### CROSS-REFERENCE TO RELATED APPLICATION

This application claims the benefit of U.S. Provisional Application Ser. No. 61/880,517, filed Sep. 20, 2013, the entire contents of which are incorporated herein.

### FIELD

The present disclosure relates to an improved multi-factor authentication system.

### BACKGROUND

These days, data security plays an important role, especially in various applications where confidentiality, authentication, integrity and/or non-repudiation are given importance. For example, a human subject can be authenticated for various purposes (e.g., data access, access to private networks, the internet, access to certain resources, etc.).

For increased security, multiple factors may be used for authentication. For example, instead of authenticating a human subject over a single factor or attribute, the human subject may be authenticated only if multiple factors or attributes have been verified. This can provide an enhanced security to the given system.

### SUMMARY

However, a conventional multi-factor authentication system entails time-consuming process (e.g., slower authentication) relative to a single-factor authentication system and, therefore, often results in low user satisfaction. Sometimes, the conventional multi-factor authentication system is cumbersome to use as it requires a number of inputs to be given in a non-streamlined way. Therefore, there is a need for an improved multi-factor authentication system that streamlines the multi-factor authentication process to enhance the user satisfaction and convenience.

In some embodiments, a method for authenticating a user on an electronic device is provided. The method may comprise receiving an input of a first user identifier; verifying the first user identifier for the device; after the first user identifier is verified for the device, requesting an input of a second user identifier that is distinct from the first user identifier; receiving the input of the second user identifier, wherein as the input of the second user identifier is received, the device detects a third user identifier that is distinct from the first and second user identifiers; and verifying simultaneously the second user identifier and the third user identifier.

In some embodiments, the first user identifier (e.g., user ID, password, etc.) may be associated with an identifier of the electronic device (e.g., device serial number, IP number, phone number, etc.). The second user identifier may comprise selection of a color (e.g., a single color selection or multi-color selection), selection of a picture (e.g., a single picture or multiple pictures), and/or a touch swipe gesture (e.g., connecting a series of dots in a certain pattern, swiping a touch-screen with a finger in a pre-registered pattern). The third user identifier may comprise eye movement of the user, fingerprint, facial recognition, etc. The third user identifier may be correlated with the second user identifier, and the correlation between the second and third user identifiers is verified. For example, the eye movement should match the movement of the finger (e.g., made while inputting the touch swipe gesture) for successful authentication of both the eye movement and the touch swipe gesture.

In some embodiments, an electronic device (e.g., a handheld device, a smartphone, a laptop, etc.) for authenticating a user is provided. The device may comprise a display (e.g., touch-sensitive display); a communication module for communicating with an external device; one or more processors; and a memory for storing one or more programs. The one or more programs, when executed by the one or more processors, cause the device to perform the operations comprising: receiving an input of a first user identifier; verifying the first user identifier; after the first user identifier is verified, requesting an input of a second user identifier that is distinct from the first user identifier; receiving the input of the second user identifier from the device; detecting a third user identifier that is distinct from the first and second user identifiers, as the input of the second user identifier is received; and verifying simultaneously the second user identifier and the third user identifier.

In some embodiments, a non-transitory computer readable medium (e.g., RAM, ROM, DRAM, SRAM, etc.) storing one or more instructions for an electronic device with a display is provided. The instructions, when executed by the device, cause the device to: receive an input of a first user identifier; verify the first user identifier; after the first user identifier is verified, request an input of a second user identifier that is distinct from the first user identifier; receive the input of the second user identifier from the device; detect a third user identifier that is distinct from the first and second user identifiers, as the input of the second user identifier is received; and verify simultaneously the second user identifier and the third user identifier.

### BRIEF DESCRIPTION OF THE DRAWINGS

FIG. 1 shows the overall system architecture and high level components

FIG. 2 shows the overall workflow and steps in the integrated multi-factor authentication system

FIG. 3 shows a human beings hand with a extended index finger, a common gesture used for pointing, specifying or indicating

FIG. 4 shows a human being's eye focusing on a specific location

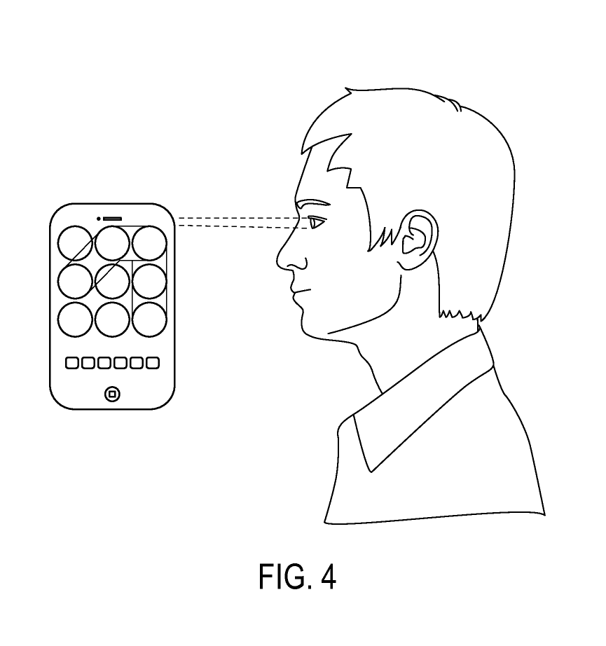

FIG. 5 shows the sequential steps in recreating a swipe pattern on a touch screen.

### DETAILED DESCRIPTION OF THE INVENTION

Various embodiments of a multi-factor authentication system that streamlines the authentication process for the user are described herebelow. The descriptions are made in reference to a specific embodiment or example of the system for simplicity and brevity of explanation. However, various modifications can be made without departing from the core concept of the multi-factor authentication system described below as will be apparent to a person of ordinary skill in the art. The same concept may be applied in various other contexts that are not explicitly described here such as in applications involving different types of authentication mechanisms.

In some embodiments, a multi-factor authentication system that authenticates a human subject (e.g., user) using three independent factors is provided. The three factors include, e.g., “something the subject knows (a shared secret)”, “something the subject has (a physical token you have control of)” and “something the subject is (a biometric).” This system can take advantage of the proliferation of smart devices (mobile phones, tablets, smart TV's, etc.) that incorporate a front facing camera and that are uniquely addressable. The system can be implemented using many different types of authentication mechanisms.

Specifically, the three specific authentication mechanisms may be:
1) Something the subject knows (a shared secret)—e.g., a color (e.g., the specific color the user has previously registered), a pattern (e.g., connecting a series of dots as the user has previously registered), a touch gesture, a motion gesture, passwords, PINs, etc.
2) Something the subject has—e.g., a physical token the user possess and otherwise has control of, a smartphone or tablet which are uniquely addressable via a telephone number, a IP address, an application downloaded onto the device, or any combination thereof, etc.
3) Something the subject is (a biometric)—a fingerprint, a hand geometry, a facial recognition based on a unique facial geometry biometric, a voice recognition, an iris scan, etc.

The list provided above is only exemplary, and various other mechanisms are possible.

The system achieves the ease of use and delivers a delightful end-user experience by requiring the user to remember only the first category factor (something the user knows) and authenticating the other two category factors automatically while the user operates the device without requiring an active input from the user.

For example, the authentication process for authenticating a user for a handheld electronic device may involve the following:
1) A user is operating a particular device and trying to access certain resources in the device.
2) The user enters a user identifier using the device (e.g., user ID and password).
3) After the user enters the user identifier, the device confirms that it is being operated by a rightful user (e.g., the registered user) via out-of-band signaling and also confirms that the device is in possession of the rightful user. At this stage, the second category factor for the device is verified.
4) The system sends a link to the device.
5) After the user clicks on the link that is messaged to the device, an application is launched. The application is used to directly authenticate the user.
6) The application prompts the user to provide a color touch swipe gesture (e.g., or any other first category factor).
7) While the user is entering the color touch swipe gesture, the system not only authenticates the color touch swipe gesture but also activates the facial recognition mechanism (e.g., or any other third category factor). The facial recognition mechanism detects an eye movement in real-time. This simultaneous authentication system may mitigate the risk of replay attacks, for instance via a photograph or video.
8) Eye movement is monitored in real-time and correlated with the entry of the gesture swipe.

For example, when the user attempts to access certain electronic resources, the user can be prompted for a user identifier (username, email address, etc.). After entering the user identifier, the authentication system looks up the user identifier in its directory and determines the user is an authorized user of the particular device.

The authentication system sends a message to the device. Upon receiving the message on the device the user clicks on the received embedded link that launches an application on the device when clicked by the user. This application turns on the camera on the device and captures an initial image of the user.

Immediately thereafter, the application displays a series of dots arranged in a grid. Below the grid of dots is a color pallet. The user selects their secret color and then moves their finger (on a touch screen), or a trackpad/mouse to connect the dots associated with their secret gesture swipe.

While the user is entering their gesture swipe the camera is still turned on and the system is doing two things:

1) The system observes the users eye movement and when it detects sufficient eye movement from the initial image captured, additional images may be captured. This insures that a picture of the user hasn't been placed in front of the camera.

2) Since the system securely stores the users secret color gesture swipe, as the user is entering it, the system can determine whether the eye movement is consistent with the entry of the color gesture swipe. This avoids attacks perpetrated by pointing the camera at a video. One embodiment that improves the resilience, changes the order of the color pallet each time. This ensures that even if a video is created to be used in a replay attack, the eye movement will not correlate to the user selecting their secret color.

This multi-factor authentication method overcomes the known security defects of existing verification systems and increases user satisfaction. In particular, it delivers a delightful user experience by reducing authentication time and not requiring the recall of complex passwords or PINs. Whereas existing authentication technology performs each identification function in a cumbersome, nonobvious and sequential process, this method performs the verification step simultaneously and reduces the user's total authentication time.

Existing gaze detection programs direct the user's eyes via screen messages (i.e. look to the bottom right). This function frequently fails to authenticate valid users because of the complexity and nonobvious process. The current method does not direct the user's eye movement but merely verifies that the movements correlate with the user's swipe pattern as it is entered. This mechanism performs the same gaze detection function while requiring less instruction.

The user selects his or her personal color and enters a personal tactile gesture. Introducing the color variable exponentially increases the total possible swipe combinations. The vulnerability in existing gesture swipe technology that a user's swipe leaves visible marks on the surface of the screen, compromising the secrecy of the tactile pattern, is ameliorated by introducing a color variable. Each time the user is prompted to enter their color gesture swipe the order of the colors on the palette is randomly changed.

Simply put, the embodiment described above utilizes the facial recognition and the eye movement associated with entering the color gesture swipe to further enhance the strength and accuracy of the authentication system and prevent the risk of a system error or deliberate attacks on the system.

As such, in some embodiments, a multi-factor authentication system utilizes the integration and correlation of multiple independent factors or authentication mechanisms to achieve 1) higher assurance in the identity of the subject, 2) greater resilience of the system to specific types of attacks, and/or 3) substantially easier and more intuitive user experience.

For example, the system described above integrates two independent authentication mechanisms, a color gesture swipe and facial recognition. As will be apparent to a person of ordinary skill in the art, more than two mechanisms can be integrated or correlated (e.g., three factors, four factors, five factors, six factors of the same or different categories), and various other mechanisms from the ones listed above can be alternatively or additionally used.

In the following description of the disclosure and embodiments, reference is made to the accompanying drawings in which it is shown by way of illustration specific embodiments that can be practiced. It is to be understood that other embodiments and examples can be practiced and changes can be made without departing from the scope of the disclosure.

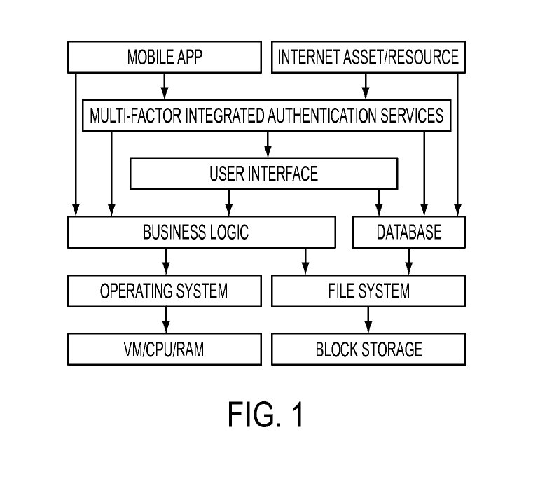

FIG. 1 illustrates the major components of the system and their relationships in a high level architecture. In this illustrated embodiment, the system contains two major components:
1) internet accessible services that receive and respond to authentication requests from any asset or resource that a user may be trying to access; and
2) a mobile application that runs on a mobile device which incorporates a touch screen and front facing camera.

When the user attempts to access a private asset or resource, the target resource must make a access control decision based on the identity of the user. The target resource can use the invention to establish the identity of the user with a very high level of confidence, specifically National Institute of Standards and Technology (NIST) Level 4 assurance.

NIST has established 4 Levels of Identity Assurance (Special Publication 800-63) where Level 1 only establishes uniqueness and persistence of identity and Level 4 provides the highest level of identity assurance consistent with requirements established for military-grade authentication.

NIST Level 4 authentication requires the use of 3 independent factors, including at least 1 biometric factor.

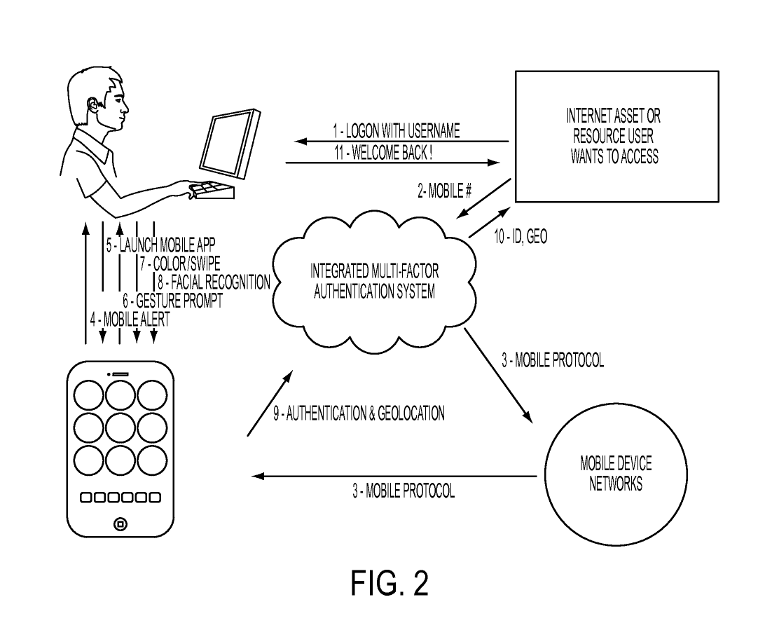

FIG. 2 illustrates the workflow and steps involved in the authentication process.

In Step 1, the user attempts to access an internet resource which is private and protected by one or more access management policies. In order for the internet resource to make the access control decision it must accurately establish the identity of the user. To establish the identity of the user the internet resource invokes the integrated multi-factor authentication service. The integrated multi-factor authentication service prompts the user to enter their username or user identifier. This is referred to as the asserted identity.

In Step 2, the internet resource can either:
1) Look up the asserted identity in a local directory to determine the associated mobile device; or
2) Utilize the integrated multi-factor authentication service to perform the directory lookup.

In some embodiments, determination on which option is to be utilized is made based on the role that the internet resource chooses relative to the management of Personally Identifiable Information associated with the asserted identity.

In Step 2, either the mobile device number or the asserted user identity is passed to the integrated multi-factor authentication service.

In Step 3, the system utilizes the mobile device networks and associated protocols to communicate with a user's registered mobile device. The mobile device networks are able to locate and communicate with the mobile device in real-time. In some embodiments, the system is implemented such that the user mobile device displays an alert within 1 or 2 seconds of the user entering the username.

In Step 4, the user receives the alert from their mobile device. In some embodiments, this is accomplished through the combination of a visual alert appearing on the screen of the mobile device and the device emitting a sound—e.g., a bell, chime, buzz or ring.

In Step 5, the user acknowledges the alert, which in turn launches the mobile app which has already been downloaded to the mobile device.

In Step 6, after the mobile app has launched, the device immediately displays the user interface prompting the user to select their secret color and enter their secret gesture. At this time the mobile app also turns on the mobile device front facing camera.

In Step 7, as the user is selecting the secret color, the first facial image is captured including the position of the eyes. As the user continues to enter the swipe gesture, additional images can be captured as each dot is connected. The eye movement can be detected with each image and can be compared to the relative position of the color and specific dots connected as the gesture swipe is entered.

As the user is entering their secret color and gesture swipe, there is required a hand-eye coordination. The user can only accurately direct the movement of their finger if the user is simultaneously moving the eyes to focus on the next point toward which the user's finger is also moving.

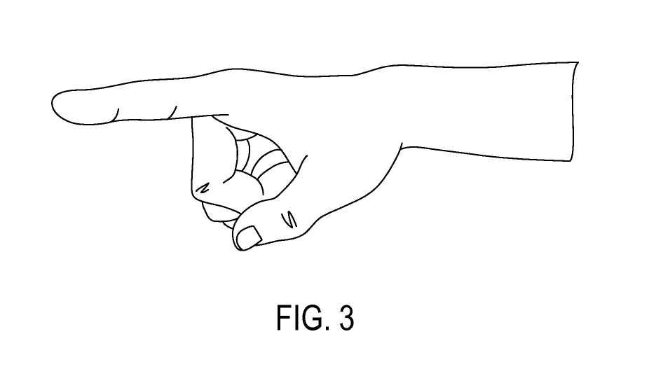

FIG. 3 illustrates the digit (index finger) which, in some embodiments, is used by a human being to input a swipe gesture. As explained above, the fine motor control necessary to select a specific color and then to connect specific dots displayed on the screen can be accomplished with hand-eye coordination. In this embodiment, it is precisely this hand-eye coordination which is exploited as the basis for the integration of the two independent authentication mechanisms. Those skilled in the art will recognize that there are many other embodiments, which can exploit the same correlation between many other alternative or additional authentication mechanisms.

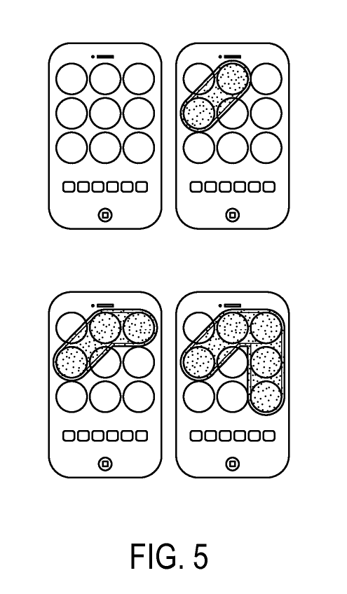

FIG. 5 illustrates the steps necessary in performing a gesture. Simply put, the user focuses on a specific point on the screen where the user then places their finger. The eye then moves to the next point as the finger moves to follow.

Since the gesture swipe, previously recorded by the user during registration, is known to the system, the system knows precisely what eye movement to expect while the gesture swipe is being entered.

In one embodiment of the invention a facial image can be captured as the finger moves to each new point on the screen. Eye movement can be detected and this can be correlated with the expected behavior. If the eye movement and the expected behavior correlate then the system has a high degree of assurance that the camera is in fact capturing images of a live human being and the specific human being who is entering the gesture swipe.

Common attacks on facial recognition include the use of still images and/or video images. For instance in one attack a criminal has compromised the user's security, stolen their registered mobile device and has knowledge of their secret color and gesture pattern. The criminal takes a high resolution picture of the user and points the mobile device camera directly at the picture. The criminal then selects the secret color and enters the gesture pattern. However, the multi-factor authentication system of the present disclosure is able to easily detect such an attack because the attacks would not be able to provide eye movement input that is required for authentication.

In some embodiments, a more sophisticated attack may attempt to use a video of the real user's eye movement as the user is entering the swipe gesture. However, it would be very difficult to reach the precise correlation between the attacker's swipe gesture motion and the playback of the recorded eye movement of the real owner. Further, in some embodiments, for enhanced security to prevent such sophisticated attacks, the system employs the integration and correlation between not only the swipe gesture and eye movement but also between the swipe gesture and fingerprint detected from the swipe gesture.

Further, in some embodiments, the color palette, from which the user selects the secret color, is made to randomly change the locations of the individual colors within the palette for every authentication event. It, therefore, becomes highly unlikely that a recorded eye movement video would successfully correlate to the current locations of the user's secret color on the screen.

In Step 8, only after the above correlation comparisons between the 2 independent authentication mechanisms are successful is the facial recognition protocol completed and evaluated.

In Step 9, the entirety of the authentication data, for all 3 factors is returned to the integrated multi-factor authentication service for evaluation. In this embodiment the geolocation information from the device is also returned to the integrated multi-factor authentication service. Such information can also be correlated with past authentication behavior and such information can be similarly correlated.

In Step 10, the authenticated identity of the user and their current location can now be returned to the internet resource, which can then make a accurate access management decision.

In Step 11, after the internet resource has successfully completed the access management decision the user is allowed access to the resource.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

What is claimed:

1. A method for authenticating a user on an electronic device, the method comprising:
receiving an input of a first user identifier;
verifying the first user identifier for the device;
after the first user identifier is verified for the device, requesting an input of a second user identifier that is distinct from the first user identifier;
receiving the input of the second user identifier, wherein as the input of the second user identifier is received, the device detects a third user identifier that is distinct from the first and second user identifiers; and
verifying simultaneously the second user identifier and the third user identifier.

2. The method of claim 1, wherein the first user identifier is associated with an identifier of the electronic device.

3. The method of claim 1, wherein the second user identifier comprises selection of a color.

4. The method of claim 1, wherein the second user identifier comprises a touch swipe gesture on a touch-sensitive screen of the device.

5. The method of claim 1, wherein the third user identifier comprises eye movement of the user.

6. The method of claim 1, wherein the third user identifier is correlated with the second user identifier, and the correlation between the second and third user identifiers is verified.

7. An electronic device for authenticating a user, the device comprising:
a display;
a communication module for communicating with an external device;
one or more processors;
a memory for storing one or more programs, wherein the one or more programs, when executed by the one or more processors, cause the device to perform the operations comprising:
receiving an input of a first user identifier;
verifying the first user identifier;
after the first user identifier is verified, requesting an input of a second user identifier that is distinct from the first user identifier;
receiving the input of the second user identifier from the device;
detecting a third user identifier that is distinct from the first and second user identifiers, as the input of the second user identifier is received; and
verifying simultaneously the second user identifier and the third user identifier.

8. The device of claim 7, wherein the first user identifier is associated with an identifier of the electronic device.

9. The device of claim 7, wherein the second user identifier comprises selection of a color.

10. The device of claim 7, wherein the second user identifier comprises a touch swipe gesture on a touch-sensitive screen of the device.

11. The device of claim 7, wherein the third user identifier comprises eye movement of the user.

12. The device of claim 7, wherein the third user identifier is correlated with the second user identifier, and the correlation between the second and third user identifiers is verified.

13. A non-transitory computer readable medium storing one or more instructions for an electronic device with a display, which, when executed by the device, cause the device to:
receive an input of a first user identifier;
verify the first user identifier;
after the first user identifier is verified, request an input of a second user identifier that is distinct from the first user identifier;
receive the input of the second user identifier from the device;
detect a third user identifier that is distinct from the first and second user identifiers, as the input of the second user identifier is received; and
verify simultaneously the second user identifier and the third user identifier.

14. The medium of claim 13, wherein the first user identifier is associated with an identifier of the electronic device.

15. The medium of claim 13, wherein the second user identifier comprises selection of a color.

16. The medium of claim 13, wherein the second user identifier comprises a touch swipe gesture on a touch-sensitive screen of the device.

17. The medium of claim 13, wherein the third user identifier comprises eye movement of the user.

18. The medium of claim 13, wherein the third user identifier is correlated with the second user identifier, and the correlation between the second and third user identifiers is verified.
